(19) United States
(12) Patent Application Publication
(10) Pub. No.: US 2023/0411899 A1
(43) Pub. Date: Dec. 21, 2023

(54) ELECTRICAL COUPLING APPARATUS

(71) Applicant: Interplex Industries, Inc., East Providence, RI (US)

(72) Inventor: Richard Schneider, Livonia, MI (US)

(21) Appl. No.: 18/211,383

(22) Filed: Jun. 19, 2023

Related U.S. Application Data
(60) Provisional application No. 63/354,139, filed on Jun. 21, 2022.

(51) Int. Cl. H01R 13/516; H01R 13/73; H02J 7/00; B60L 53/16; B60L 53/35

(52) U.S. Cl. CPC H01R 13/516; H01R 13/73; H02J 7/0045; B60L 53/16; B60L 53/35; H01R 2201/26

(57) ABSTRACT

A coupling apparatus having first and second connector parts. The first connector part includes first busbars held in a first housing, and the second connector part includes second busbars held in a second housing. The first and second busbars may be annular and are connected to electrical conductors, respectively. A gimbal helps connect the second connector part to a mount, which may be moved by a lift. The gimbal is operable to permit the second connector part to pivot about a plurality of axes relative to the mount. The first and second connector parts are configured to be coupled together to electrically connect the first busbars to the second busbars.

### CROSS-REFERENCE TO RELATED APPLICATION(S)

This application claims the benefit of priority under 35 U.S.C. § 119(e) to U.S. Provisional Patent Application No. 63/354,139 filed on 21 Jun. 2022, which is herein incorporated by reference.

### TECHNICAL FIELD

The present disclosure relates to an electrical coupling apparatus for connecting electronic and/or electrical parts having multiple current paths.

### BACKGROUND

In an electronic system, it is typically necessary to establish electrical connections between constituent parts of the system. In some situations, the parts to be connected together have multiple current paths. The multiple current paths may be low voltage data signals and/or power flows. Connectors for multiple path parts, i.e., multi-path connectors, are typically plug and socket connections that are difficult and, thus, expensive to manufacture. Moreover, conventional multi-path connectors tend to be susceptible to wear and tear and do not accommodate the misalignment of the parts being connected together. More specifically, conventional multi-path connectors typically do not accommodate angular misalignment, i.e., components of a conventional multi-path connector must be in a particular angular position relative to each other in order to be connected together. However, in some applications, it would be desirable to connect together the components regardless of their angular orientation relative to each other.

Based on the foregoing, it would be desirable to provide an improved electrical coupling apparatus for electrically connecting together multi-path parts.

### SUMMARY

A coupling apparatus is disclosed having first and second connector parts and a mount having a main plate. The first connector part includes a plurality of arcuate first busbars arranged concentrically and a first housing holding the first busbars. The second connector part includes a plurality of arcuate second busbars arranged concentrically and a second housing holding the second busbars. A gimbal is secured to the second connector part and helps connect the second connector part to the mount. The gimbal is operable to permit the second connector part to pivot about a plurality of axes relative to the mount. The first and second connector parts are configured to be coupled together to electrically connect the first busbars to the second busbars.

### BRIEF DESCRIPTION OF THE DRAWINGS

The features, aspects, and advantages of the present invention will become better understood with regard to the following description, appended claims, and accompanying drawings where:

FIG. 1 is a partially exploded side perspective view of a coupling apparatus having first and second connector parts;

FIG. 2 is a partially exploded bottom perspective view of the first connector part of the coupling apparatus of FIG. 1;

FIG. 3 is an exploded top perspective view of portions of the first connector part of FIG. 2;

FIG. 4 is a close-up perspective view of a hub of a lower shell of a housing of the first connector part of FIG. 2;

FIG. 5 is an exploded top side perspective view of portions of the second connector part of FIG. 1;

FIG. 6 is a perspective view of portions of the second connector part of FIG. 1;

FIG. 7 is a perspective sectional view of the second connector part and a portion of the first connector part when they are connected together;

FIG. 8 shows a top perspective view of a float cage spaced from a skid plate and a shim plate, all of which are components of the coupling apparatus of FIG. 1;

FIG. 9 shows a bottom perspective view of the float cage of FIG. 8;

FIG. 10 shows a side perspective view of an assembly that has the float cage, the skid plate and the shim plate connected to a mount;

FIG. 11 is a bottom perspective view of the assembly of FIG. 10; and

FIGS. 12-17 shows side sectional views of various stages of the first and second connector parts being connected together using a lift.

### DETAILED DESCRIPTION OF ILLUSTRATIVE EMBODIMENTS

It should be noted that in the detailed descriptions that follow, identical components have the same reference numerals, regardless of whether they are shown in different embodiments of the present disclosure. It should also be noted that for purposes of clarity and conciseness, the drawings may not necessarily be to scale and certain features of the disclosure may be shown in somewhat schematic form.

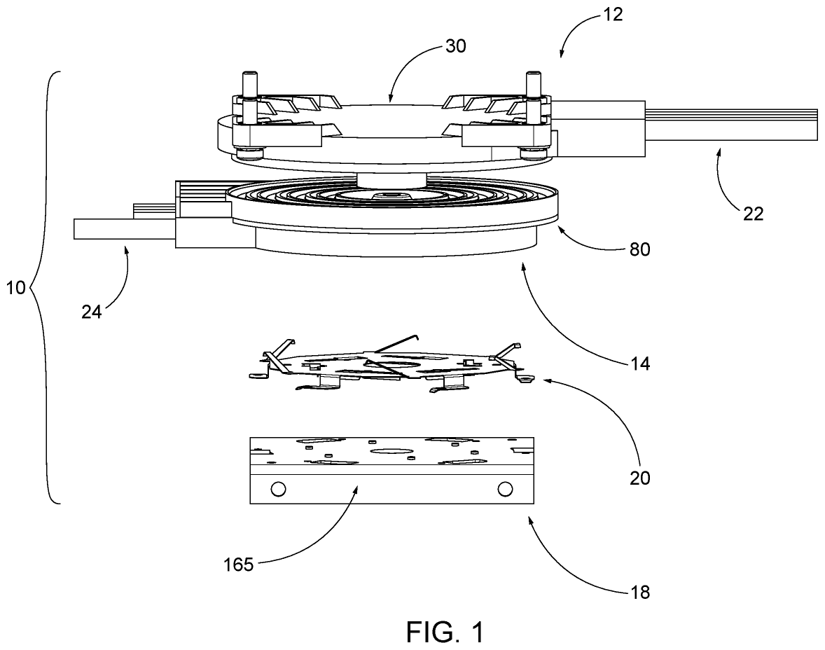

Referring now to FIG. 1, there is shown a coupling apparatus 10 constructed in accordance with this disclosure. The coupling apparatus 10 generally includes an upper or first connector part 12 configured for connection to a lower or second connector part 14, which is movably connected to a mount 18 by a float cage 20. The first connector part 12 is connected to conductors 22, while the second connector part 14 is connected to conductors 24. Thus, when the first and second connector parts 12, 14 are connected together, the conductors 22 are electrically connected to the conductors 24, respectively. The conductors 22, 24 may carry electric power and/or data signals, as described below.

For purposes of facilitating description, components of the coupling apparatus 10 may be described with regard to X, Y, Z spatial coordinates, which are as follows: the X-axis extends in the direction of the conductors 22, 24; the Y-axis extends through the first and second connector parts 12, 14; and the Z-axis extends between flanges 165 of the mount 18.

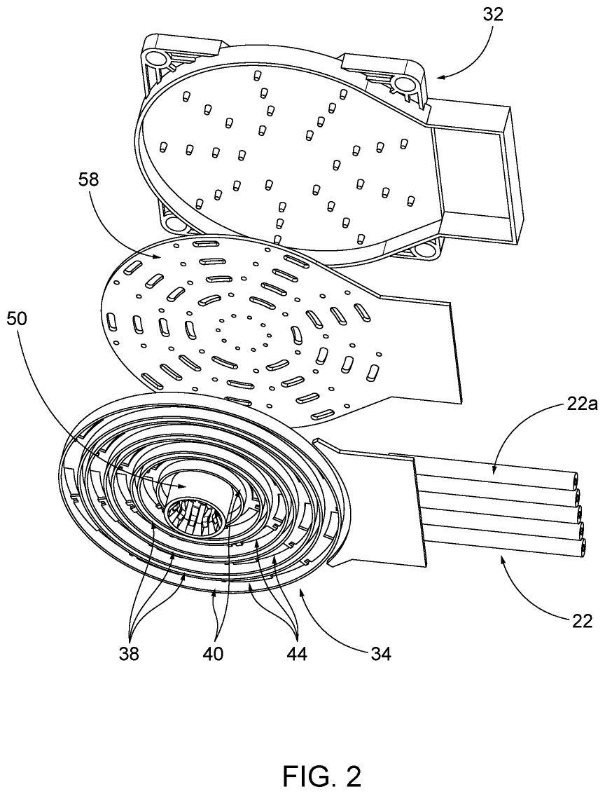

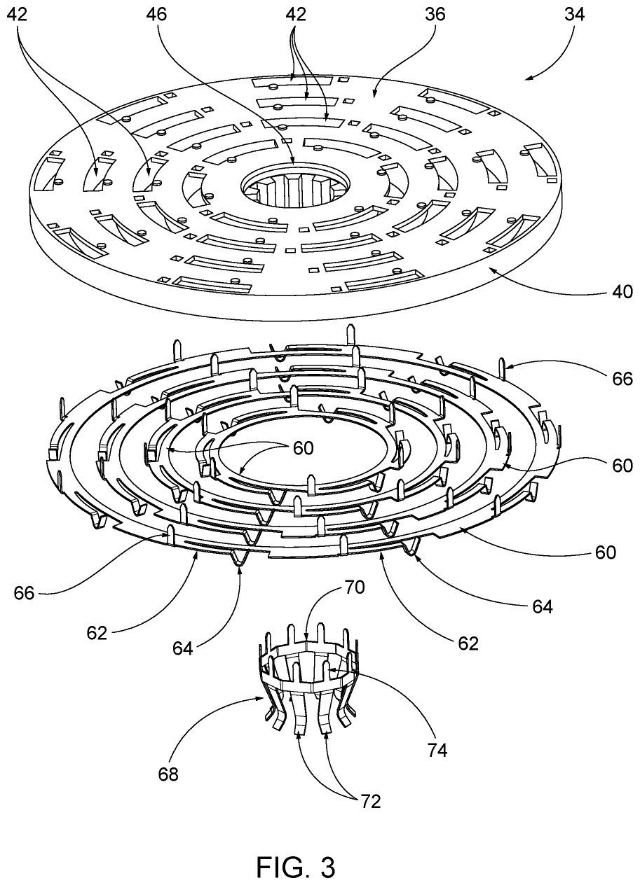

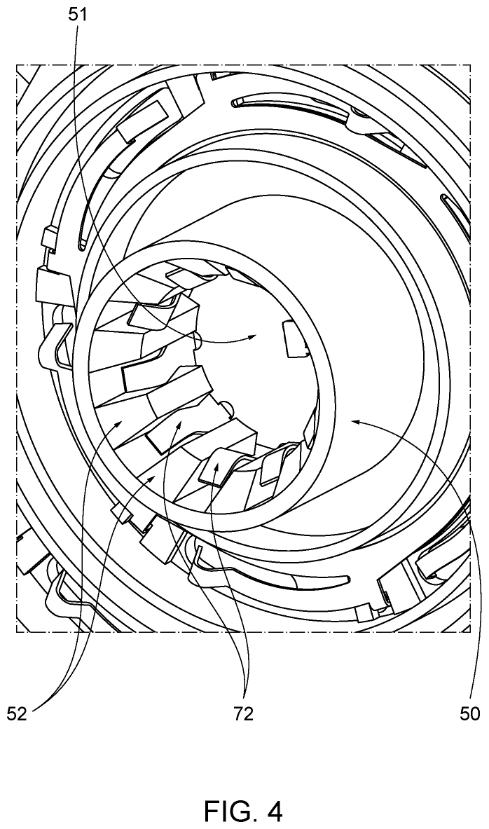

Referring now also to FIGS. 2-4, the first connector part 12 includes a plastic housing 30, which may have an upper shell 32 connected to a lower shell 34. The lower shell 34 has a main plate 36 to which concentric annular structures 38, 40 are joined and extend outwardly therefrom. In the shown embodiment, there are three structures 38 and two structures 40; however, different numbers of these structures may be used. The structures 38 each have a double wall to define an internal space in-between, while the two structures 40 each have a single wall. In the shown embodiment, the two structures 40 bracket the structures 38. The structures 38, 40 have different diameters and are spaced apart by annular spaces 44. Inside each space 44, a series of slots 42 and accompanying openings are circumferentially arranged and extend through the main plate 36. An enlarged central opening 46 extends through the main plate 36. A cylindrical hub 50 is joined to the main plate 36 around the central opening 46 and defines an interior hollow 51. Inside the hollow 51, a plurality of ribs 52 extend radially inward and are separated by spaces. Bottom end portions of the ribs 52 are sloped or beveled, as shown in FIG. 4.

A printed circuit board (PCB) 58 with a plurality of internal conductive traces is disposed between the upper and lower shells 32, 34. A plurality of concentric annular busbars 60 are disposed in the annular spaces 44 of the lower shell 34, respectively and are mechanically and electrically connected to the PCB 58 through the openings in the main plate 36 of the lower shell 34. Each of the busbars 60 is formed from a conductive metal such as copper or a copper alloy and is electrically connected to one of the conductors 22, such as through the traces in the PCB 58. In addition, each busbar 60 has a plurality of contacts 62 integrally joined thereto. Each contact 62 is joined in cantilever fashion to its respective busbar 60 and has a downwardly-projecting head 64 formed by a V-shaped bend in the contact 62. In addition, each head 64 is aligned with a slot 42 in the main plate 36 to allow the head 64 to resiliently retract into the slot 42 when contacting a corresponding busbar 100 in the second connector part 14 (as discussed more fully below). A plurality of stakes 66 are secured in openings in the PCB 58 and are connected to traces therein.

A resilient sleeve 68 is mechanically and electrically connected to the PCB 58 and extends downwardly through the central opening 46 of the main plate 36 and into the hollow 51 of the hub 50. The sleeve 68 is formed from a conductive metal such as copper or a copper alloy and includes a collar 70, which has a mostly closed circumference so as to have a substantially annular shape. A plurality of legs 72 are integrally joined to the collar 70 and extend downwardly and inwardly therefrom. The legs 72 are spaced apart and have lower portions that are bent outwardly to provide the sleeve 68 with a flared lower end, which is open. A plurality of stakes 74 are also joined to the collar 70 and extend upwardly therefrom. The stakes 74 are aligned with the legs 72 and are secured in openings in the PCB 58 and are electrically connected to one of the conductors 22a through traces in the PCB 58. The conductor 22a to which the stakes 74 are connected may be a ground conductor. Inside the hub 50, the legs 72 of the sleeve 68 are disposed in the spaces between the ribs 52.

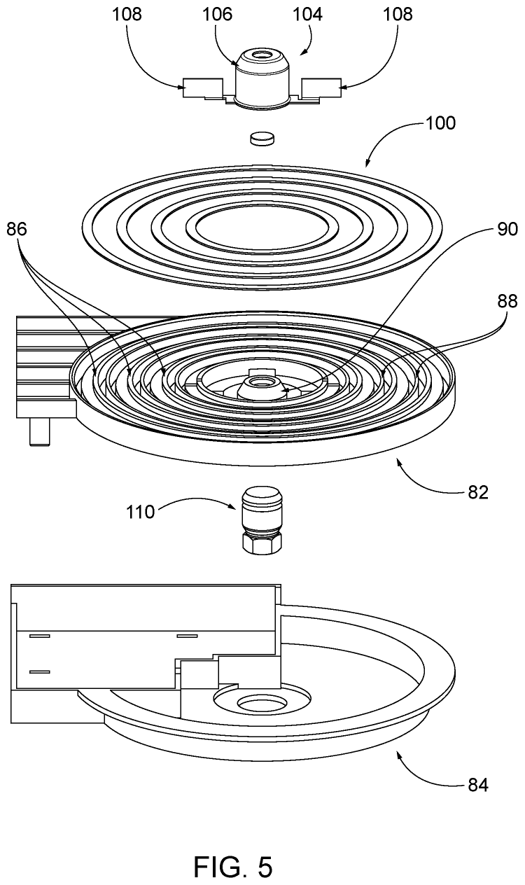

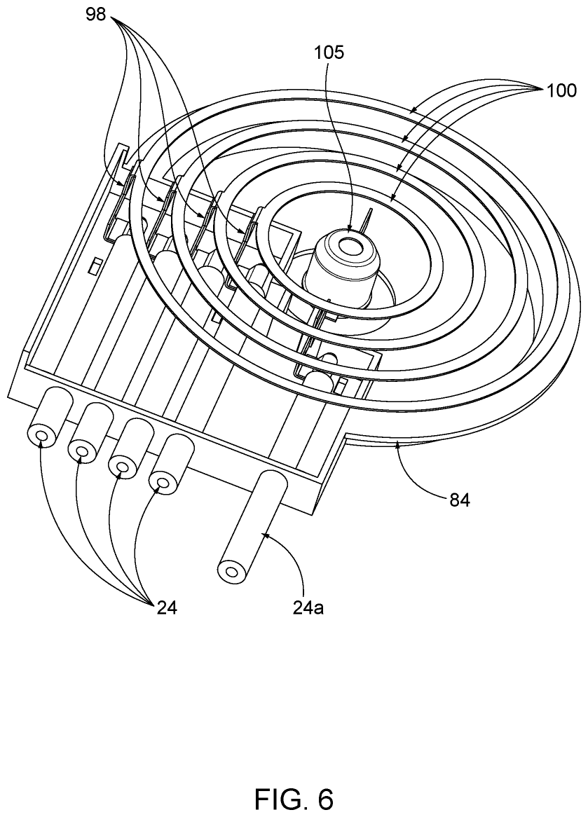

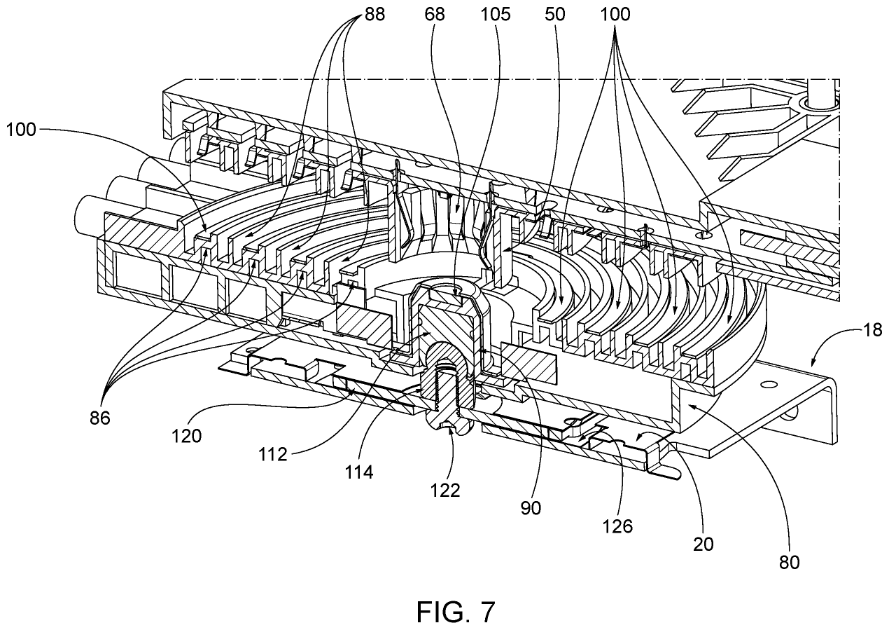

Referring now to FIGS. 1 and 5-7, there are shown views of major components of the second connector part 14. Generally, the second connector part 14 includes a plastic housing 80, which may have an upper shell 82 connected to a lower shell 84. The upper shell 82 includes interconnected concentric annular structures 86, 88 and a central hub 90. As best shown in FIG. 7, each structure 86 has a stepped configuration with a horizontal tread joined between a pair of vertical risers. Each structure 88 is a vertical wall joined by a bottom wall to one or more lower risers of one or more adjacent structures 86. The hub 90 is spaced radially inward from the structures 86, 88.

A plurality of concentric annular busbars 100 are disposed on the treads of the structures 86, respectively and are mechanically and electrically connected to the conductors 24 which extend into a rectangular portion of the lower shell 84. Each of the busbars 100 is formed from a conductive metal such as copper or a copper alloy and is electrically connected to one of the conductors 24 by a fitting 98. As will be discussed more fully below, the busbars 100 make electrical connections with the contacts 62 of the busbars 60 of the first connector part 12 when the first and second connector parts 12, 14 are connected together.

A casing 104 is mounted to the hub 90 of the upper shell 82. The casing 104 is formed from a conductive metal such as copper or a copper alloy and includes a hollow cylindrical body 106 joined between a pair of outwardly extending wings 108. The body 106 of the casing 104 is snugly disposed over the hub 90, while one of the wings 108 is electrically connected to one of the conductors 24a. The conductor 24a to which the casing 104 is connected may be a ground conductor. The body 106 has a beveled upper end. As will be described more fully below, a mounting core 105 (which includes the casing 104 and the hub 90) is received in the sleeve 68 of the first connector part 12 when the first and second connector parts 12, 14 are connected together.

A gimbal 110 is secured to the second connector part 14 and is operable to permit the second connector part 14 to pivot about the X, Y and Z axes relative to the mount 18. The gimbal 110 includes a socket piece 112 movably fastened to a ball piece 114. The socket piece 112 has a substantially cylindrical outer surface and an interior spherical socket. A spherical ball of the ball piece 114 is movably trapped inside the socket. The socket piece 112 is secured inside the hub 90, while the ball piece 114 is secured to the skid plate 120 by a threaded screw 122. The socket piece 112, the hub 90 and the casing 104 form the mounting core 105.

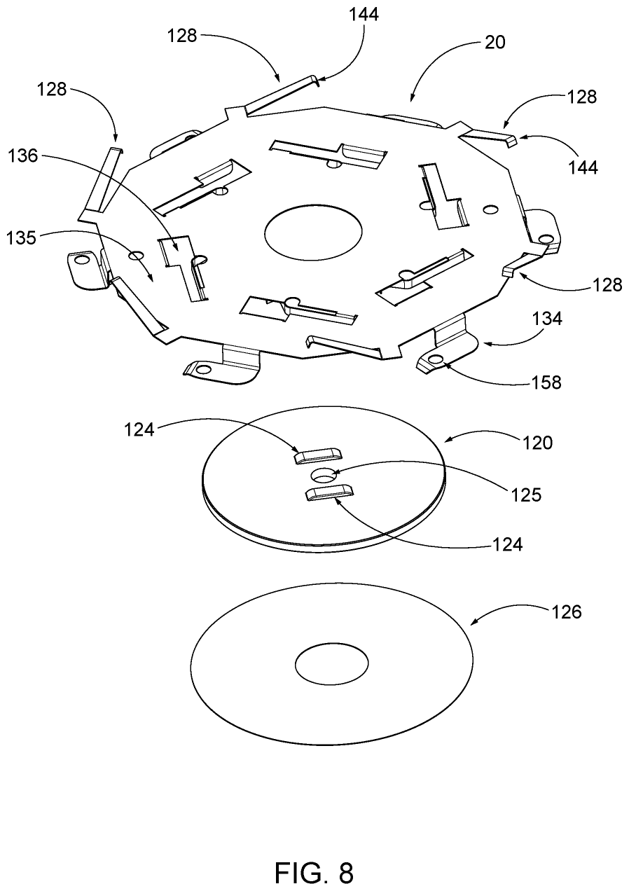

Referring now to FIG. 8, the skid plate 120 is circular and has embossed top rails 124 that bracket a center opening 125 through which the screw 122 extends when it is threadably secured inside a threaded bore in the ball piece 114 of the gimbal 110. The top rails 124 prevent the gimbal 110 from turning when the screw 122 is threaded into the ball piece 114. The skid plate 120 is trapped between the float cage 20 and the mount 18. The shim plate 126 may be disposed between the skid plate 120 and the mount 18. The shim plate 126 has an enlarged central opening that allows it to freely slide horizontally. The shim plate 126 helps reduce friction between the skid plate 120 and the mount 18.

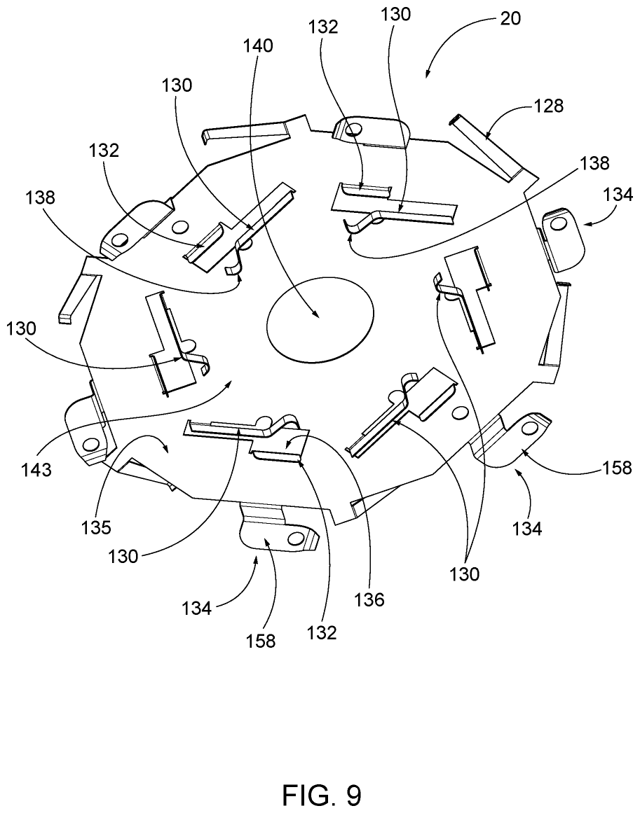

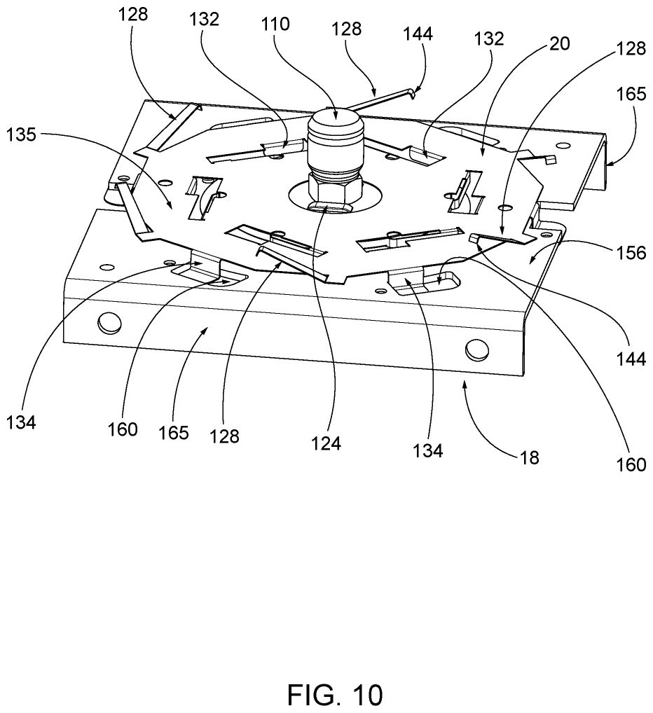

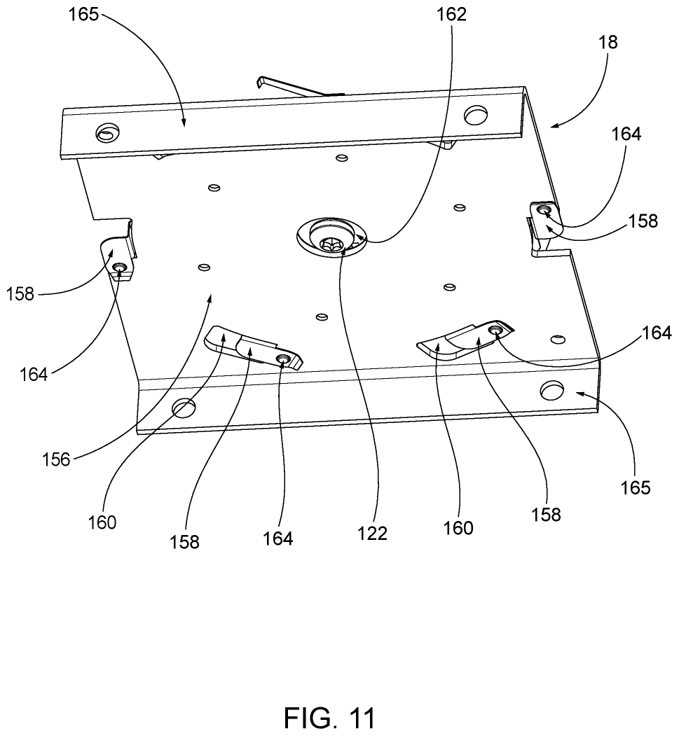

Referring now also to FIGS. 9-11, the float cage 20 has a top side with a plurality of vertical spring beams 128 and a bottom side with a plurality of horizontal spring beams 130, a plurality of standoffs 132 and a plurality of fasteners 134. The vertical spring beams 128, the horizontal spring beams 130, the standoffs 132 and the fasteners 134 may be stamped from a main plate 135 of the float cage 20. The stamping of the horizontal spring beams 130 and the standoffs 132 forms openings 136.

Each horizontal spring beam 130 includes a horizontal body joined to the main plate 135 at a bend. A crook-shaped engagement portion 138 is joined at a bend to the body so as to extend inward, toward a central opening 140 of the main plate 135. The engagement portion 138 is resiliently movable outward. The horizontal spring beams 130 are arranged in a ring around the central opening 140 to define a generally circular region 143 that is coaxial with the central opening 140. The skid plate 120 (and the shim plate 126) are disposed in the region 143 such that rounded bends of the engagement portions 138 abut an outer circumference of the skid plate 120. As will be described more fully below, when the first and second connector parts 12, 14 engage each other and the second connector part 14 is moved, the skid plate 120 may move horizontally (in the X-Z plane) against the biases of the horizontal spring beams 130. When the first and second connector parts 12, 14 are later separated from each other, the biases of the horizontal spring beams 130 move the skid plate 120 to re-center it so as to be coaxial with the central opening 140.

Each vertical spring beam 128 is joined in cantilever fashion to a tab on the periphery of the main plate 135 and slopes upwardly therefrom. A free end of the vertical spring beam is bent to form an engagement portion 144. The vertical spring beams 128 are arranged around the circumference of the main plate 135 in a spaced apart manner and are resiliently deflectable in a vertical direction. The engagement portions 144 abut a planar bottom surface of the lower shell 84 of the second connector part 14 when the second connector part 14 is in a horizontal position. As will be described more fully below, when the first and second connector parts 12, 14 engage each other and the second connector part 14 is moved, the second connector part 14 may tilt such that the bottom surface of the lower shell 84 moves out of the X-Z plane so as to no longer be parallel with the mount 18. In doing so, the lower shell 84 will deflect some of the vertical spring beams 128 downwardly, against their biases. When the first and second connector parts 12, 14 are later separated from each other, the biases of the downwardly-deflected vertical spring beams 128 move the second connector part 14 such that the bottom surface of the lower shell 84 moves back to being parallel with the mount 18.

The standoffs 132 and the fasteners 134 also extend downwardly from the main plate 135. The standoffs 132 abut a base plate 156 of the mount 18 and ensure that the main plate 135 of the float cage 20 is spaced above the base plate 156 of the mount 18 a sufficient distance to permit the skid plate 120 and the shim plate 126 to freely slide over the base plate 156. Each of the fasteners 134 is generally L-shaped and includes a vertical leg joined at about a right angle to a foot 158 having a hole extending therethrough. The legs of the fasteners 134 extend through slots 160 in the base plate 156 to position upper surfaces of the feet 158 against bottom surfaces of the base plate 156. The bottom surface of the base plate 156 has nubs 164 protruding therefrom, which are pressed through the holes in the feet 158, respectively, thereby securing the feet 158 to the base plate 156. In this manner, the fasteners 134 secure the float cage 20 to the mount 18.

In addition to having the slots 160, the base plate 156 of the mount 18 includes a central opening 162 that accommodates a head of the screw 122 securing the gimbal 110 to the skid plate 120.

From the foregoing, it should be appreciated that the securement of the gimbal 110 to the skid plate 120 and the entrapment of the skid plate 120 between the float cage 20 and the mount 18 movably attaches the second connector part 14 to the mount 18.

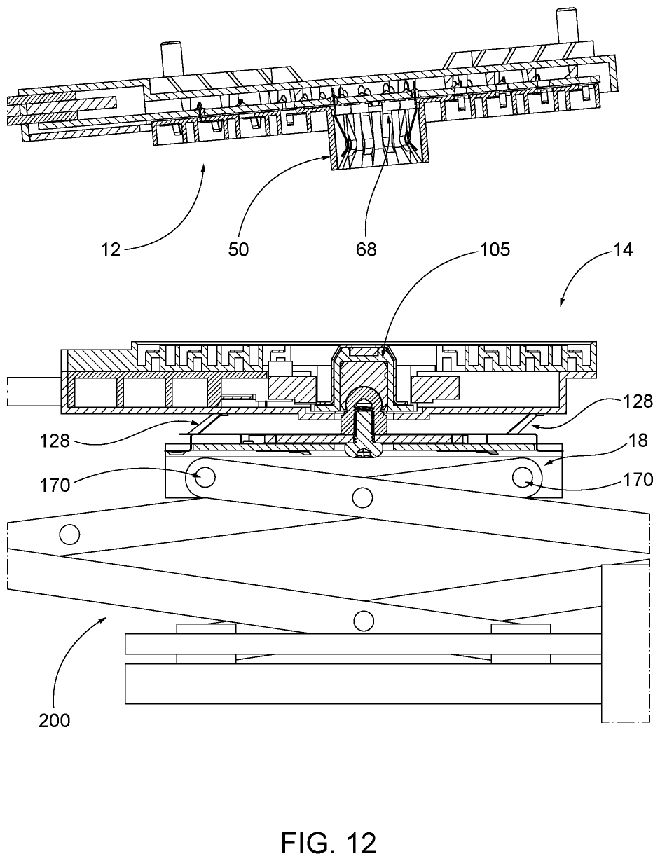

The base plate 156 is joined between a pair of downwardly-extending flanges 165. The flanges 165 may be connected by pins 170 to a lift 200 (shown in FIGS. 12-17) that is operable to vertically move the mount 18 and the second connector part 14 mounted thereto. The lift 200 may be a scissors-type lift having a plurality of arms connected together by pivot joints and may be powered electrically or hydraulically.

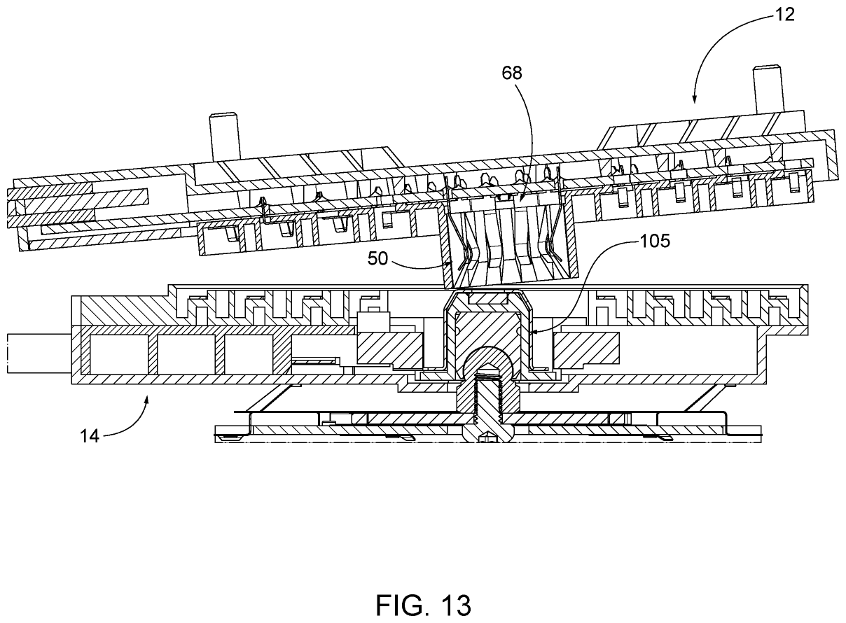

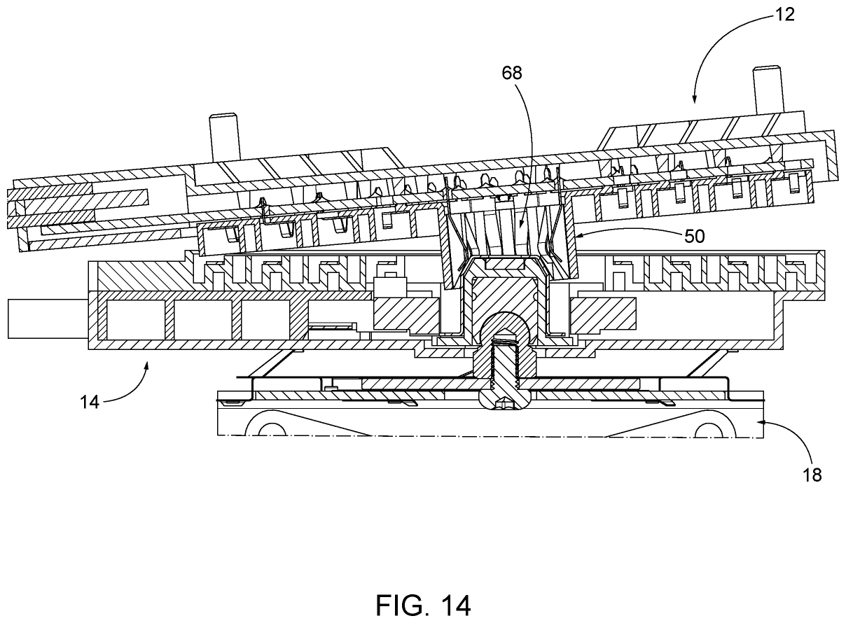

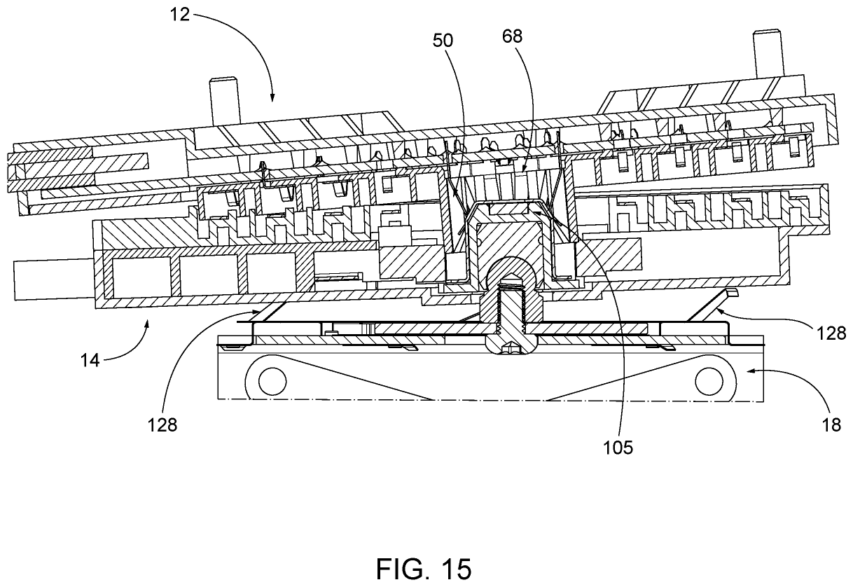

Referring now to FIGS. 12-17, the operation of the coupling apparatus 10 will now be described. In FIG. 12, the first connector part 12 is spaced above the second connector part 14, which is secured by the mount 18 to the lift 200. The first connector part 12 and the second connector part 14 are misaligned in the X-direction and may also be misaligned in the Z-direction. In addition, the first connector part 12 is tilted relative to the second connector part 14. The lift 200 is actuated to move the second connector part 14 upward, into a position very close to or just touching the first connector part 12, as shown in FIG. 13. In this position, the beveled upper surface of the mounting core 105 just barely overlaps the beveled bottom end portions of the ribs 52 of the hub 50 in the X-direction on a left side. The lift 200 continues to move the second connector part 14 upward, which causes the beveled upper surface of the mounting core 105 to slide over the sloped bottom end portions of the ribs 52 (on the left side), which applies a force (directed to the right) to the mounting core 105, thereby causing the skid plate 20 and the rest of the second connector part 14 to move to the right, as shown in FIG. 14. Continued upward movement of the lift 200 applies a downwardly-directed force to the left side of the mounting core 105, thereby causing the mounting core 105 and the rest of the second connector part 14 to pivot to the left about the ball piece 114 of the gimbal 110, as shown in FIG. 15. This downward pivot deflects one or more of the vertical spring beams 128 on the left side of the coupling apparatus 10 and spaces one or more of the vertical spring beams 128 on the right side of the coupling apparatus 10 from the bottom surface of the lower shell 84 of the second connector part 14.

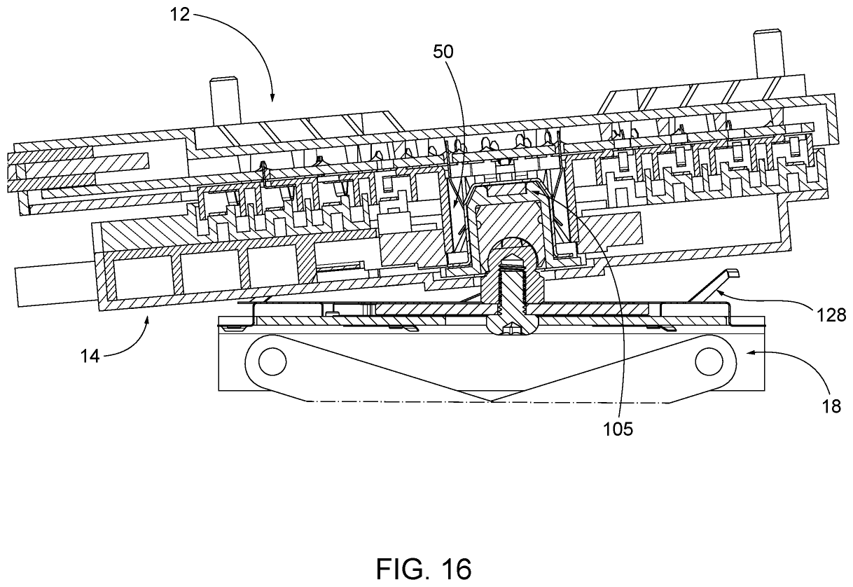

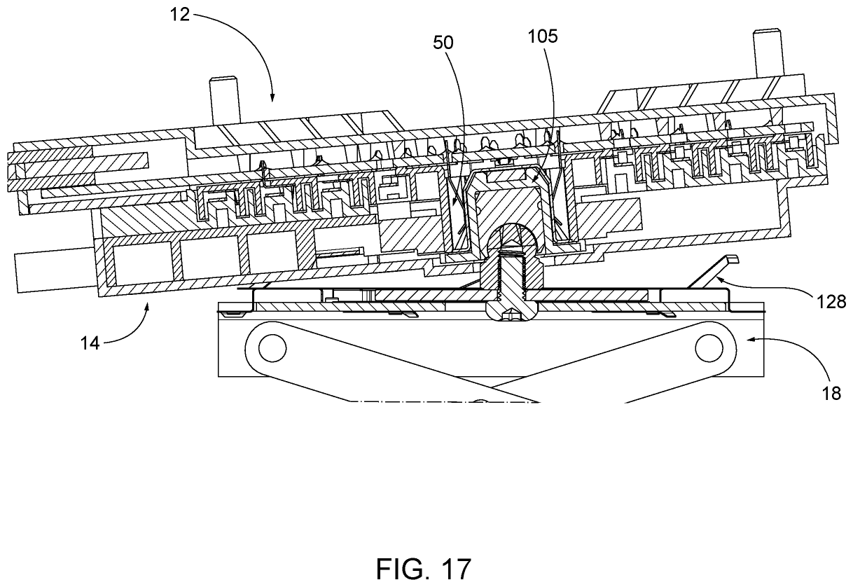

The second connector part 14 continues to pivot until the second connector part 14 is tilted at the same angle as the first connector part 12 and is otherwise aligned with the first connector part 12, as shown in FIG. 16. For example, the busbars 60 of the first connector part 12 are now aligned with the busbars 100 of the second connector part 14, the internal spaces of the structures 38 of the first connector part 12 are now aligned with the structures 88 of the second connector part 14 and the hub 50 of the first connector part 12 is coaxial with the mounting core 105 of the second connector part 14. The lift 200 continues to move upward until the first and second connector parts 12, 14 are fully connected, as shown in FIG. 17, whereby the contacts 62 of the busbars 60 are pressed against the busbars 100 to make electrical connections therewith, the structures 88 are disposed inside the structures 38, respectively, and the mounting core 105 is disposed inside the sleeve 68 and is electrically connected thereto.

When the first and second connector parts 12, 14 are connected together as described above, the sleeve 68 is electrically connected to the casing 104, thereby electrically connecting the conductor 22a to the conductor 24a, which may establish a grounding path through the coupling apparatus 10. In addition, the busbars 60 of the first connector part 12 are electrically connected to the busbars 100 of the second connector part 14, thereby connecting the other conductors 22 to the other conductors 24, respectively.

The coupling apparatus 10 is particularly well suited for applications where the first and second connector parts 12, 14 need to be connected together when they are at any angular position relative to each other. One such application is use of the coupling apparatus 10 in a battery charging system for electric vehicles. In such a system, the first connector part 12 may be mounted to the underside of an electric vehicle and electrically connected to the battery cells of the vehicle, while the second connector part 14 may be mounted to the docking structure of a charging station. In this regard, the mount 18 and the lift 200 may be part of the docking structure and may be connected to the second connector part 14 by the float cage 20 and the skid plate 120. The vehicle may be maneuvered to position the first connector part 12 over the second connector part 14. The docking structure is then moved to connect the second connector part 14 to the first connector part 12. A force sensor (which is connected to a control system of the charging station) may be used to control movement of the docking structure to ensure the proper connection of the first and second connector parts 12, 14. In addition, the force sensor may be used to detect if the vehicle moves during use (e.g. a person enters/exits the car while it is charging), which signals the charging station to dynamically adjust the height of the docking structure to maintain contact, or to prevent damage from being overly-compressed.

It is to be understood that the description of the foregoing exemplary embodiment(s) is (are) intended to be only illustrative, rather than exhaustive. Those of ordinary skill will be able to make certain additions, deletions, and/or modifications to the embodiment(s) of the disclosed subject matter without departing from the spirit of the disclosure or its scope.

What is claimed is:

1. A coupling apparatus, comprising:
a first connector part comprising:
a plurality of arcuate first busbars arranged concentrically; and
a first housing holding the first busbars;
a second connector part comprising:
a plurality of arcuate second busbars arranged concentrically; and
a second housing holding the second busbars;
a mount having a main plate;
a gimbal secured to the second connector part and helping connect the second connector part to the mount, the gimbal being operable to permit the second connector part to pivot about a plurality of axes relative to the mount; and
wherein the first and second connector parts are configured to be coupled together to electrically connect the first busbars to the second busbars.

2. The coupling apparatus of claim 1, further comprising:
a float cage helping connect the gimbal to the mount such that the gimbal may move vertically and horizontally relative to the mount, the float cage having a base plate.

3. The coupling apparatus of claim 2, further comprising a skid plate secured to the gimbal, the skid plate being trapped between the base plate of the float cage and the main plate of the mount, the skid plate being horizontally and vertically movable.

4. The coupling apparatus of claim 3, wherein the float cage biases the gimbal to a centered position in the horizontal direction.

5. The coupling apparatus of claim 4, wherein the float cage comprises a plurality of first spring structures connected to the base plate and being operable to bias the skid plate and the gimbal toward the centered position.

6. The coupling arrangement of claim 5, wherein the skid plate is circular and wherein the first spring structures have engagement portions that press against an outer circumference of the skid plate.

7. The coupling apparatus of claim 5, wherein the float cage further comprises a plurality of second spring structures connected to the base plate and being operable to bias the second connector part to a horizontal position.

8. The coupling apparatus of claim 7, wherein the second spring structures slope upwardly to bent engagement portions;
wherein the second spring structures are resiliently deflectable in a vertical direction;
wherein when the second connector part is in a horizontal position, all of the engagement portions of the second spring structures are in contact with a bottom wall of the second housing, and when the second connector part is moved to a tilted position, at least one of the second spring structures is deflected downward and at least one of the engagement portions of the second spring structures is spaced from the bottom wall of the second housing.

9. The coupling apparatus of claim 7, wherein the float cage further comprises a plurality of standoffs for spacing the base plate above the main plate of the mount to permit the skid plate to move vertically and horizontally; and
wherein the first spring structures and the standoffs are located on a bottom side of the base plate and the second spring structures are located on a top side of the base plate.

10. The coupling apparatus of claim 9, wherein the first spring structures, the standoffs and the second spring structures are stamped from the base plate.

11. The coupling apparatus of claim 1, wherein the gimbal is operable to permit the second connector part to pivot about at least three axes relative to the mount, and wherein the gimbal is movable vertically and horizontally relative to the mount.

12. The coupling apparatus of claim 1, further comprising a plurality of electrical first conductors and a plurality of electrical second conductors;
wherein each of the first busbars is electrically connected to one of the first conductors and each of the second busbars is electrically connected to one of the second conductors;
wherein the first connector part further includes a conductive sleeve electrically connected to a particular one of the first conductors;
wherein the second connector part further includes a conductive mounting core electrically connected to a particular one of the second conductors; and
wherein when the first and second connector parts are connected together, the mounting core is disposed inside the sleeve to make an electrical connection therewith.

13. The coupling apparatus of claim 12,
wherein the first housing comprises:
a first central hub defining an interior socket; and
a plurality of arcuate first structures defining arcuate first spaces in-between;
wherein the second housing comprises:
a second central hub;
a plurality of arcuate second structures defining arcuate second spaces in-between; and
wherein the first bus bars are disposed in the first spaces of the first housing and the second bus bars are disposed in the second spaces of the second housing.

14. The coupling apparatus of claim 13, wherein the first busbars and the second busbars are annular;
wherein the first structures of the first housing are annular, and the second structures of the second housing are annular;
wherein the first central hub is cylindrical and is coaxial with the first structures, which are disposed radially outward from the first central hub; and
wherein the second central hub is coaxial with the second structures, which are disposed radially outward from the second central hub.

15. The coupling apparatus of claim 14, wherein at least a plurality of the first structures is double walled to define gaps in between; and
wherein at least a plurality of the second structures is configured to be received in the gaps of the double walled first structures when the first and second connector parts are connected together.

16. The coupling apparatus of claim 14,
wherein the sleeve is mounted inside the first central hub;
wherein the mounting core includes a conductive casing mounted over the second central hub, the casing being electrically connected to the particular one of the second conductors; and
wherein when the first and second connector parts are connected together, the casing is disposed inside the sleeve to make an electrical connection therewith, thereby electrically connecting the particular one of the first conductors to the particular one of the second conductors.

17. The coupling apparatus of claim 16, further comprising:
a float cage secured to the mount and having a base plate, the float cage biasing the gimbal to a centered position in the horizontal direction; and
a skid plate secured to the gimbal, the skid plate being disposed between the base plate of the float cage and the main plate of the mount, the skid plate being horizontally and vertically movable relative to the mount.

18. The coupling apparatus of claim 17, wherein the gimbal comprises a socket piece having an interior socket;
a ball piece having a ball;
wherein the socket piece is secured inside the second central hub and the ball piece is secured to the skid plate; and
wherein the ball of the ball piece is moveably disposed inside the socket of the socket piece.

19. The coupling apparatus of claim 18, wherein the float cage comprises:
a plurality of first spring structures connected to the base plate and being operable to bias the skid plate and the gimbal toward the centered position;
a plurality of second spring structures connected to the base plate and being operable to bias the second connector part to a horizontal position; and
wherein the first spring structures are located on a bottom side of the base plate and the second spring structures are located on a top side of the base plate.

20. A battery charging system for an electric vehicle, the battery charging system comprising the coupling apparatus of claim 1 and further including a charging station having a lift connected to the mount;
wherein the first connector part is mounted to an underside of the electric vehicle and is electrically connected to battery cells of the vehicle; and
wherein the lift is operable to vertically move the second connector part into engagement with the first connector part to electrically couple the second connector part to the first connector part, thereby electrically connecting the charging station to the battery cells of the vehicle.
